(19) United States
(12) Patent Application Publication
(10) Pub. No.: US 2024/0375462 A1
(43) Pub. Date: Nov. 14, 2024

(54) VALVE SYSTEM FOR A TUBELESS WHEEL

(71) Applicant: SPORT COMPONENTS AG, CH-8003 ZÜRICH (CH)

(72) Inventors: Pius KOBLER, Zürich (CH); Dominik EGGERT, Zürich (CH); Arno LENZI, Adliswil (CH); Nico SPINELLI, Zürich (CH)

(73) Assignee: SPORT COMPONENTS AG, CH-8003 ZÜRICH (CH)

(21) Appl. No.: 18/691,154

(22) PCT Filed: Sep. 18, 2022
(86) PCT No.: PCT/EP2022/075872

§ 371 Date: Mar. 12, 2024

(30) Foreign Application Priority Data
Sep. 27, 2021 (DE) 10 2021 124 985.6

(51) Int. Cl. B60C 29/00; B60C 5/12; B60C 29/02

(52) U.S. Cl. CPC B60C 29/005; B60C 5/12; B60C 29/02

(57) ABSTRACT

The invention relates to a valve system (6, 62, 64, 66) for a tubeless wheel, the wheel comprising a rim (1) and a tire (2), which form a tire/rim volume (10) that can be filled with air, and a puncture protection insert (5, 52, 54, 55, 56) positioned inside the tire/rim volume (10), the valve system comprising a valve stem body (82, 84, 86), which extends along a valve axis (A) and has a first end and a second end, and a valve base (72, 73, 74, 75, 76) adjoining said second end, the second end being positioned in the tire/rim volume (10) when the valve system (6, 62, 64, 66) is mounted on the wheel. The purpose of this is to simplify the insertion of a tube-like cannula or hollow needle of a tool for filling or extracting sealing fluid through the valve system into the tire/rim volume. According to the invention, this is achieved in that the valve base has an outer circumference that increases continuously along the valve axis (A) in the direction of the tire/rim volume, forming a thickened valve base end, and the valve system (6, 62, 64, 66) also comprises a sleeve (4, 42, 43, 44, 45, 46) having a first end and a second end, wherein the first end of the sleeve (4, 42, 43, 44, 45, 46) connects to the thickened valve base end (72, 73, 74, 75, 76) and the sleeve (4, 42, 43, 44, 45, 46) extends from there along the valve axis in a direction oriented away from the valve stem body (82, 84, 86).

### BACKGROUND OF THE INVENTION

### Field of the Invention

The invention relates to a valve system for a tubeless wheel, the wheel comprising a rim and a tire, which form a tire/rim volume that can be filled with air, and an insert positioned inside the tire/rim volume, the valve system comprising a valve stem body, which extends along a valve axis and has a first end and a second end, and a valve base adjoining this second end, the second end being positioned in the tire/rim volume when the valve system is mounted on the wheel. The invention also relates to a tubeless wheel with such a valve system.

### Discussion of Related Art

The use of tubeless tires on bicycles is becoming increasingly popular. Originally used on mountain bikes, so-called “tubeless technology” is becoming increasingly popular on other types of bicycles, such as racing bikes, cyclocross bikes, and so-called “gravel bikes.” By contrast with conventional tubed tires, in which the air is contained in an inner tube inserted into the tire, in tubeless tires the tire casing and the rim form a hollow tire/rim volume that can be filled with air by means of a valve that is built into the rim and is sealed against the rim. In addition, a liquid sealant is introduced into the wheel interior via this valve, which is distributed throughout the wheel interior and forms a fluid-tight and gas-tight sealing film covering the inner surfaces of the tire/rim volume. Since these sealants are mostly based on a latex liquid, they are commonly referred to as so-called “sealing milk” in reference to their visual appearance. Tubeless tires allow the tire to be used with a lower internal pressure than conventional tube systems, which improves the rolling characteristics and traction of the tire on the riding surface. In addition, the tire's susceptibility to flats is reduced, since minor damages to the tire casing are sealed from the inside by the sealing film on the surfaces delimiting the tire/rim volume. A “tire/rim volume” is therefore understood to be the entire inner space of the wheel, which can be filled with air, is separated from the outside environment by the walls of the tire and rim, and is sealed against air leakage.

EP 3 107 742 B1 discloses a valve system of this generic type with a self-sealing one-way valve in the form of rubber flaps that seal the valve system in relation to the tire/rim volume and prevent air from escaping from the tire/rim volume once the valve core is removed from the valve stem body so that a tool for measuring the fill level of the liquid sealant or for filling the sealant can be at least partially inserted into the tire/rim volume. In this case, a tube-like cannula or hollow needle of the tool is inserted along the valve axis through an inner duct of the valve stem body and through the arrangement of rubber flaps sealing the valve system against air leakage into the tire/rim volume and in this way establishes a continuous connection for the exchange of the liquid sealant between the tire/rim volume and an external liquid reservoir of the tool. In a similar manner, a sealant that is already present in the tire/rim volume can also be sucked out from the tire/rim volume via this tubular cannula or hollow needle by inserting such a cannula until it touches the bottom of the tire, with the wheel positioned so that the valve is at the lowest point of the wheel (i.e. the valve is in the “6 o'clock position” relative to the entire circumference of the wheel) and the liquid sealant collects at this lowest point in the vicinity of the valve. This can be necessary, for example, when the sealant has reached its intended service life. In this context, a “valve axis” means the central axis of the air duct, which is integrated into the valve stem body and is generally positioned in a rotationally symmetrical fashion around this central axis, through which the air is pumped into the tire/rim volume of the wheel and also through which the hollow needle or cannula of the above-mentioned tool is inserted for filling the liquid sealant into the tire/rim volume or pumping or sucking the liquid sealant out from the tire/rim volume.

To improve the stability of tubeless wheels and in particular to improve protection against so-called “pinch punctures” when extreme impact stresses on the wheel occur, e.g. when riding over large rocks, curbs, etc., it has become standard practice to integrate additional puncture protection inserts (so-called “tire inserts”) into the tire/rim volume of the wheel. These are usually ribbon-shaped strips made of a shock-absorbing, but at the same time sufficiently rigid, porous plastic, which are inserted into the interior of the tire along the outer circumference of the wheel or into the contact region between the rim and tire casing in the wheel interior, thus protecting the tire from punctures or stabilizing it from the inside (i.e. from the interior of the wheel). Such puncture protection inserts make it more difficult for impact stresses acting on the wheel in a radial direction at the rim of the wheel to cause punctures and are intended to enable riding with lower air pressure. Numerous versions of such tire inserts are known from the prior art. However, such tire inserts are very inconvenient for the mounting and removal of the tire and for the filling of the sealing liquid, since they block the valve opening on the inside of the tire and can thus more or less hinder the filling of sealing liquid into the interior of the wheel.

It is true that there are puncture protection inserts with openings or gaps such as slots or holes, as disclosed for example in WO 2018/020081 A1. The primary purpose of these openings, however, is to reduce the weight of the puncture protection insert. Since the puncture protection inserts can be displaced in an azimuthal or rolling direction within the tire, the above-mentioned openings can assume any relative position in relation to the valve system of the wheel. It is therefore left to chance which relative position such an opening in the puncture protection insert assumes in relation to the valve system. Only with a very favorable relative position between the puncture protection insert and the valve system, in which an opening in the puncture protection insert and the valve system are approximately aligned with each other, can the hollow needle or tube-like cannula of the above-mentioned tool for filling or extracting the sealant be inserted through the opening of the puncture protection insert into the tire/rim volume. But if the relative positioning is unfavorable, the puncture protection insert blocks such an insertion of the hollow needle or cannula into the tire/rim volume. Sealing fluid therefore cannot be reliably introduced into the tire.

US 2007/0017614 A1, for example, has also disclosed inserts that have duct-like structures incorporated into their material that are connected to the valve base of the valve system. US 2007/0017614 A1, however, acknowledges that these duct-like structures are subject to very powerful deformations due to the flexing movements of the insert during the rolling of the wheel when used as intended, which can even lead to the complete blockage of them if the insert is compressed in such a way that the inner diameter of the duct-like structure is reduced to almost zero. Such solutions are therefore only suitable for tires in which only air is to be supplied to the tire interior, since this air can also pass through gaps or pores past the blocked duct and into the tire/rim volume or the wheel interior if the pressure applied is sufficiently high. But introducing or removing a sealing liquid by means of a hollow needle or tube-like cannula, as is required in the self-sealing valve system disclosed in the above-mentioned EP 3 107 742 B1, is impossible with such an insert.

Furthermore, DE 20 2013 008 966 U1 discloses a driving tire with an additional inner tire which, when mounted and inflated, is positioned inside the driving tire on the rim, with the tire beads of the inner tire pressing the tire beads of the driving tire against the rim flanges from the inside, thus sealing the interior of the driving tire to prevent air loss. By means of a two-way valve with two different outlets, the interior of both the driving tire and the inner tire can be filled with air independently of each other. The air supply line to the interior of the driving tire is routed through the interior and the casing of the inner tire. When the driving tire is used as intended, flexing movements cause deformations and relative movements of the inner tire in relation to the air supply valve fixed in the rim. For this reason, the air supply line into the interior of the driving tire is embodied as a flexible and deformable connecting hose between the valve and the opening in the casing of the inner tire. Although air can still be forced through such a deformed connecting hose, it is not possible to introduce and remove a sealing fluid through the valve system using a hollow needle or tube-like cannula. This is especially true if the puncture protection insert—by contrast with the inner tire of DE 20 2013 008 966 U1, which is anchored to the rim—is not anchored in relation to the tire surrounding it, thus enabling considerable displacements in the azimuthal or rolling direction between the puncture protection insert and the tire.

EP 2 173 572 B1 also discloses a driving tire with an additional inner tire which, when mounted and inflated, seals the tire beads of the driving tire against the rim flanges from the inside. By means of a rigid locking pin, the driving tire is anchored relative to the rim so that it cannot twist relative to the rim even at high drive torques of the kind that typically occur in motorized vehicles. In addition, air can be pumped into the driving tire by means of an air duct inside the locking pin. The end of the locking pin that protrudes into the interior of the driving tire is connected to a locking plate. By means of a knurled nut impinging on the rim, a tensile force can be applied to the locking pin, which causes the locking plate to clamp the driving tire immovably against the rim. Deflector elements ensure that no conflicts occur between the inner tire and the locking pin protruding into the interior of the driving tire, thus protecting the inner tire from damage by the locking pin. As a result, the inner tire is positioned inside a rigid frame formed by the locking plate, driving tire, and rim and in particular, cannot absorb any impact stresses acting on the wheel in the radial direction. Instead, these stresses would be transferred directly to the rim flanges via the locking plate, meaning that the tire clamped between the rim and locking plate cannot provide any significant shock absorption. As a result, the inner tire cannot act as a puncture protection and instead, serves only to seal the driving tire against the rim. In addition, such a locking plate is difficult to mount inside the tire and causes an imbalance that adversely affects the concentricity of the wheel.

### SUMMARY OF THE INVENTION

The object of the present invention therefore is to provide a valve system of this generic type for a tubeless wheel that overcomes the above-mentioned disadvantages. In particular, the valve system should make it easier for a tube-like cannula or hollow needle of a tool for filling or extracting sealing fluid to be inserted through the valve system into the tire/rim volume. Obstructions caused by puncture protection inserts obstructing or blocking the valve system should be avoided.

This object is attained in that the valve base has an outer circumference that increases continuously along the valve axis in the direction of the tire/rim volume, forming a thickened valve base end, and the valve system also comprises a sleeve with a first end and a second end, wherein the first end of the sleeve adjoins the thickened valve base end and the sleeve extends from there along the valve axis in a direction oriented away from the valve stem body.

Such a valve base with an outer circumference that increases continuously along the valve axis in the direction of the tire/rim volume forms a preferably teardrop-shaped or frustoconical outer contour with a first tapered valve base end oriented toward the valve stem body and a second thickened valve base end on the opposite side of the valve base.

The valve base is connected to the valve stem body in such a way that when the valve system is mounted on the wheel, the region of the valve base between its tapered end and its thickened end engages in the valve seat of the rim. In this way, the valve base not only secures the valve stem body against being axially withdrawn from the valve-receiving opening of the rim, but also seals the gap between the valve-receiving opening and the valve stem body against air leakage from the tire/rim volume once the valve stem body is anchored against the rim under tensile preload by means of a nut when mounted on the wheel.

With regard to the object to be attained by the invention, however, it is particularly relevant that at the thickened valve base end, a connection point is formed for a sleeve that extends the valve system into the tire/rim volume. When mounted on the wheel, this sleeve can be guided through openings in a puncture protection insert that is placed in the tire/rim volume of the wheel so that the free movement of the insert in the azimuthal or rolling direction of the wheel is in fact restricted or limited, but its free movement in the radial direction of the wheel is not. In this way, a free, straight passage through a puncture protection insert, which is placed in the tire/rim volume of the wheel, is created for a cannula (that can be inserted through the valve system from the outside), which passage cannot be covered or blocked by the puncture protection insert, and this does not negatively affect the damping capacity of the puncture protection insert. The whole valve system with the sleeve is supported exclusively against the rim of the wheel.

The sleeve connects to the outer circumference of the thickened valve base end. The free inner diameter of the sleeve therefore corresponds approximately to the outer diameter of the thickened valve base end. In this way, a particularly simple and stable design of the valve system is achieved, which is based on the provision of a sleeve with a large inner diameter. This not only creates a sufficiently large free passage for a cannula or hollow needle to be inserted, but in particular also increases the stability of the sleeve against bending or buckling when external stresses act on the sleeve. This also reduces the forces acting in the contact region between the sleeve and the valve base, which reduces the risk of loosening or breakage in this contact region. This not only increases the stability of the sleeve as such, but also increases the stability and fatigue strength of its connection to the rest of the valve system.

By means of such a sleeve, the valve system can be extended along the valve axis into the tire/rim volume and the sleeve can be brought into mechanically effective engagement with the puncture protection insert. For this purpose, the insert preferably has at least one opening, whose the contour and dimensions are adapted to the contour and dimensions of the sleeve. This significantly restricts the azimuthal (relative to the axis of rotation of the wheel) displaceability of the insert in relation to the rim and valve system and achieves a mechanical anchoring of the puncture protection insert inside the wheel. In this way, a largely straight and continuous connection between the valve base or the valve stem body and the tire/rim volume of the wheel is achieved, which cannot be blocked by the puncture protection insert so that the hollow needle or tube-like cannula of a tool for filling or sucking out sealant can be pushed deep into the tire/rim volume of the wheel in a simple manner, i.e. without mechanical blockage or resistance due to the insert, until it touches the tire. The valve system according to the invention thus ensures that the puncture protection insert is positioned correctly for the insertion of the hollow needle or tube-like cannula. Not only the stability of the sleeve itself against bending or buckling in response to stresses acting on the sleeve, which is achieved by the embodiment of the valve system according to the invention, but also the improved fatigue strength of its structural connection to the valve system in response to such bending stresses induced on the sleeve, are essential prerequisites for the fact that the valve system according to the invention can anchor the puncture protection inserts, which are placed in tubeless tires, in a structurally simple manner against unwanted azimuthal relative movements in relation to the rim and thus prevent the valve from being covered by the insert. The invention also makes it possible for the valve system to be mechanically anchored to the rim exclusively in the contact region and for the sleeve that extends into the tire/rim volume to be embodied as a free end of the valve system. In this way, a two-point mounting of the valve system, in particular a mechanical anchoring in the region of the second end of the sleeve, is avoided and the tire/rim space can remain free of additional components. The simplification of the filling or removal of sealing fluid sought by the invention is achieved without negatively affecting the dynamic running properties of the tubeless wheel.

In addition, the sleeve according to the invention absorbs the forces acting on the insert during a rolling movement of the wheel, which cause an azimuthal displacement of the puncture protection insert relative to the rim and/or tire, and transfers them in the direction of the valve base and thus into the valve system. In this case, the longitudinal span of the sleeve must be dimensioned in such a way that the contact surface between the puncture protection insert and the sleeve is sufficiently dimensioned for the transmission of the force components acting in the azimuthal direction. According to the basic idea of the invention, only a touching contact between the outer surface of the sleeve and the opening in the puncture protection insert is provided, but not a force transmission between the sleeve and the insert that is effective in the direction of the valve axis. But according to possible embodiments of the invention, the passage opening in the insert can be undersized compared to the outer dimensions of the sleeve or the outer surface of the sleeve can be roughened so that in the contact region between the insert and sleeve, a friction pairing is produced that inhibits the relative movement of the two parts against each other.

Preferably, the longitudinal span of the sleeve (in relation to a direction parallel to the valve axis) is embodied in such a way that when mounted on the wheel for its intended use, the sleeve passes all the way through the puncture protection insert. This should be understood to mean that the second end of the sleeve forms a projection that protrudes into the tire/rim volume on the concave inner side of the puncture protection insert oriented away from the valve base and the rim.

Preferably, an arrangement of rubber flaps is embodied at the thickened valve base end and these flaps cover the outlet opening of the air duct at the second end of the valve stem body and seal it to prevent air from passing through. When air is pumped into the tire/rim volume and when a cannula or hollow needle is inserted through the air duct into the tire/rim volume, the rubber flaps uncover the air duct due to their flexible material and/or structural characteristics. Otherwise the air duct remains closed.

It is apparent to a person skilled in the art that for the implementation of the idea according to the invention, it is irrelevant whether the valve base and valve stem body are each embodied as separate components or whether the valve base and valve stem body form an integral component, i.e. a component without structural separation between the two sub-components. Such a structural modification has no effect on the functional properties of the valve system that are relevant to the idea of the invention. The person skilled in the art will also recognize that in the case of a valve base made of a tough-elastic material, even a slight angular inclination of the longitudinal axis of the sleeve adjoining the thickened valve base end with respect to the valve axis is possible without adversely affecting the applicability and functionality of the idea of the invention. The invention thus also extends to those valve systems in which an angular deviation between the valve axis and the longitudinal axis of the sleeve is possible due to the deformability of the valve base or the sleeve.

According to a first embodiment, the first end of the sleeve is positively connected to the valve base. Such a positive connection is particularly advantageous since it enables the valve system to be mounted in pluggable fashion without the need for special tools or aids.

In this case, the invention provides for the first end of the sleeve to have a first retaining section that tapers conically toward the valve base. This cooperates with a corresponding first retaining section of the valve base, which is positioned approximately in the transition region between the tapered valve base end and the thickened valve base end. This forms a first retaining means, which anchors the sleeve in a first axial direction (with respect to the valve axis) relative to the valve base. The smallest inner diameter at the tip of the first retaining section of the sleeve is dimensioned such that it has a value between the outer diameter of the valve stem body (usually approx. 6 mm) and the maximum outer diameter of the valve base (usually approx. 11 mm).

In addition to this, the invention provides for the sleeve to have a second retaining section, which is spaced apart from the first retaining section in the direction of the second end of the sleeve and which, like the first retaining section, reduces the free cross-section inside the sleeve. This cooperates with a corresponding second retaining section at the thickened valve base end. In this way, a second retaining means is provided, which anchors the sleeve relative to the valve base in a second axial direction (with respect to the valve axis) opposite from the above-mentioned first axial direction. According to a particularly advantageous embodiment, this second retaining means can be embodied in the form of a snap connection, which snaps in place between the sleeve and the valve base with a relative movement parallel to the valve axis. For example, in order to mount a valve system according to the invention, the sleeve can be pulled over the valve base from the valve stem body, whereby the second retaining section is pulled over the valve base (and is thus expanded and deformed) until the second retaining section has completely passed the valve base and springs back into its original shape. In this case, it is particularly advantageous that the free cross-section of the first retaining means is dimensioned smaller than the free cross-section of the second retaining means so that the first retaining means acts as a stop to limit the displaceability of the sleeve in relation to the valve base. This is also supported by the fact that the first retaining means has a greater resistance to deformation due to a widening of the cross-section of the retaining means than the second one and has a greater resistance to displacement after the second retaining means has snapped into place as mentioned above.

The stabilizing cooperation of the first and second retaining means also prevents the sleeve from tilting in relation to the valve base or valve stem body. This is effectively supported by the fact that the valve base has an intermediate section with a cylindrical circumferential surface between the first and second retaining sections. This intermediate section also constitutes the region of the maximum outer circumference of the thickened valve base end. Such a cylindrical intermediate section on the valve base constitutes an additional support surface for the sleeve and counteracts tilting of the sleeve in relation to the valve base. It is apparent to the person skilled in the art that, in the context of the idea of the invention, the specific shape of the cross-section of the circumferential surface of the intermediate section does not matter and that other, similar shapes, in addition to a cylindrical shape, can also be used for this purpose.

Alternatively, or additionally, the first end of the sleeve can be non-positively connected to the valve base. This can be achieved, for example, by the fact that at least a partial region of the sleeve is expanded with a change in shape when it is connected to the valve base and this change in shape is not completely eliminated even in the fully mounted relative positioning of the sleeve on the valve base, resulting in a frictional engagement between the sleeve and the valve base. The sleeve and valve base can be additionally joined together by gluing or friction welding.

With regard to the basic concept of the invention, it is particularly advantageous if the sleeve and the valve base are embodied of one piece. This significantly improves the ability of the valve system to produce a seal preventing fluid or gas from passing through. In addition, such a valve system is particularly easy to manufacture using a multi-component injection molding process so that as a result, the valve base and the sleeve are made of materials with different material properties. In the context of such a one-piece embodiment of the sleeve and valve base, the outer contour of the sleeve does not necessarily have to be circular or round. In practice, there are often valve systems that have a valve base with a square contour. In principle, the shape of the outer contour of the sleeve has no influence on the function of the invention. But in the case of a one-piece embodiment, it makes sense for the sleeve to have the same outer contour of the valve base.

According to another advantageous embodiment of the idea of the invention, the sleeve is stiffened by means of a supporting body. The supporting body in this case does not necessarily have to be made of a stiffer material than the sleeve, although a material pairing of hard rubber material with a Shore hardness of 50D for the supporting body and soft rubber with a Shore hardness of 45A for the sleeve (or alternatively a Shore hardness of 85A for the supporting body and a Shore hardness of 60A for the sleeve) is particularly suitable for this purpose. The stiffening effect is also achieved with identical material by increasing the combined cross-section occupied by the sleeve and supporting body (and thus the moment of inertia against torsion). In this case, the supporting body can be embodied either as an inlay inside the sleeve or as an external structure supporting the sleeve.

The idea of the invention is effectively supported by the fact that the second end of the sleeve has a retaining edge that enlarges the outer circumference of the sleeve. This restricts the relative movability of the insert in relation to the valve system even further. In particular, such a retaining edge prevents an axial movement of the insert in the direction of the second end of the sleeve, which could adversely impact the stabilizing effect of the valve system on the insert or even result in the complete loss of the effective contact between the insert and sleeve due to the insert slipping from the sleeve.

The invention also relates to a tubeless wheel with a valve system according to one of the above-mentioned technical features.

### BRIEF DESCRIPTION OF SEVERAL VIEWS OF THE DRAWINGS

The present invention will be explained in greater detail below with reference to exemplary embodiments and associated drawings. In the drawings:

FIG. 1 shows an overview of the components of a tubeless wheel with a first embodiment of a valve system according to the invention;

FIG. 2 shows a cross-sectional view of a second embodiment of a valve system according to the invention;

FIG. 2.1 shows an enlarged view of a detail from FIG. 2 (second embodiment);

FIG. 3 shows a cross-sectional view of a third embodiment of a valve system according to the invention;

FIG. 4 shows a cross-sectional view of a fourth embodiment of a valve system according to the invention;

FIG. 5 shows a cross-sectional view of a fifth embodiment of a valve system according to the invention; and

FIG. 6 shows a cross-sectional view of a fifth embodiment of a valve system according to the invention, together with tool for filling a sealant.

### DETAILED DESCRIPTION OF THE INVENTION

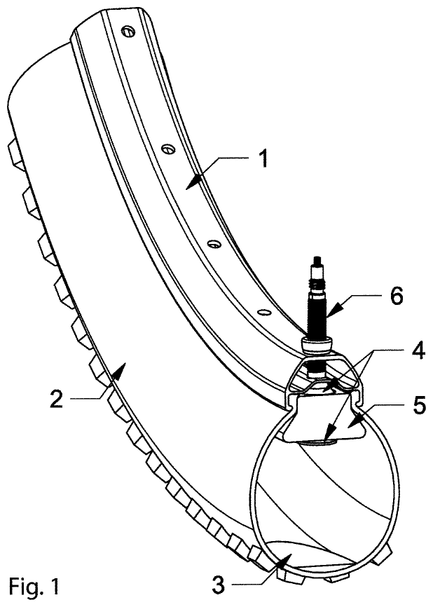

FIG. 1 shows the components of a tubeless wheel which, in addition to a rim 1 and a tire 2, also comprises a first embodiment of a valve system according to the invention for filling the wheel with air. The rim 1 and the casing of the tire 2 enclose a tire/rim volume 10, which can be sealed from the inside against air leakage by means of a liquid sealant 3. The sealant is filled into the tire/rim volume 10 by means of a tool not shown in FIG. 1 in that a hollow needle of this tool is guided through an air duct on the inside of the valve system until the free tip of the hollow needle enables the sealant, which can be fed through the hollow needle, to exit unhindered into the tire/rim volume 10. In a similar way, sealant that has reached the end of its useful life can also be sucked or pumped back out of the tire/rim volume 10 by means of such a hollow needle. In addition, a puncture protection insert 5 that extends over the entire circumference of the wheel is placed in the tire/rim volume 10 and protects the wheel from punctures that can be caused by heavy impact stresses on the wheel, e.g. when riding over curbs or the like. Such inserts can be of a wide variety of types. The puncture protection insert 5 shown as an example in FIG. 1 not only fills the rim/tire volume 10 in the region of the tire casing, but also extends into the free space between the opposing rim flanges of the rim 1 so that the beads of the tire 2 engaging in the rim flanges are held against the rim flanges from the inside by the insert 5. The valve system comprises a valve stem body 6, a valve base (not visible in FIG. 1), and a sleeve 4, which forms an extension of the valve axis of the valve system that passes through the insert 5 into the free tire/rim volume 10, i.e. the volume not filled by the insert 5.

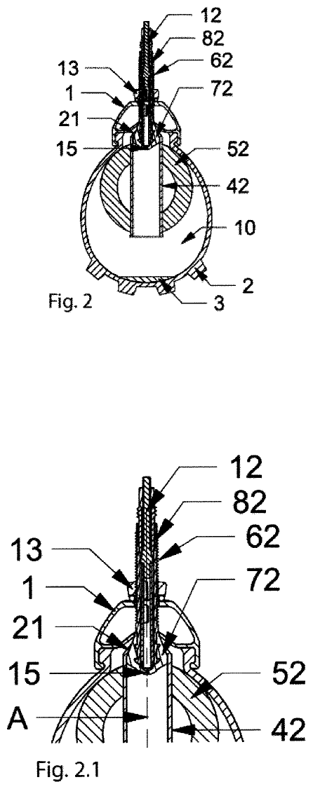

FIGS. 2 and 2.1 show a second embodiment of the valve system according to the invention. This is installed in a tubeless wheel, which comprises a rim 1, a tire 2, and a puncture protection insert 52 in the form of an annular torus. The rim 1 and the casing of the tire 2 enclose a tire/rim volume 10, which can be sealed from the inside against air leakage by means of a liquid sealant 3. The puncture protection insert 52 has a cross-section that encloses an internal cavity in annular fashion. Unlike the puncture protection insert shown in FIG. 1, the puncture protection insert 52 does not extend into the region between the rim flanges, leaving this region unoccupied. The valve system 62 comprises a valve stem body 82, a valve base 72, and a sleeve 42, which is guided through the entire cross-section of the puncture protection insert 52 and in this way forms an extension of the valve system along the valve axis through the puncture protection insert 52. For this purpose, the puncture protection insert 52 has through openings whose dimensions are adapted to the dimensions of the sleeve 42. The valve base 72 has an outer circumference that increases continuously along the valve axis in the direction of the tire/rim volume 10, thereby forming a teardrop-shaped outer contour with a first, tapered valve base end oriented toward the valve stem body 82 and a second, thickened valve base end spaced apart therefrom. On the one hand, the tapered valve base end seals the gap between the valve stem body 82 and the surrounding opening of the valve receptacle in the inner rim bed of the rim 1 and on the other hand, it secures the valve stem body 82 against being axially withdrawn from the valve-receiving opening. In addition, the valve stem body 82 is anchored against the rim 1 from the outside under tensile preloading by means of a screwable nut 13. A sleeve 42 that extends the valve system into the tire/rim volume 10 is connected to the valve base 72 at the thickened valve base end. For this purpose, the sleeve 42 is positively connected at its first end by means of a first retaining section 21, which tapers conically toward the valve base 72, to a corresponding first retaining section of the valve base 72, which is positioned approximately in the transition region between the tapered valve base end and the thickened valve base end. This first retaining section 21 prevents the sleeve 42 from detaching from the valve base 72 as a result of a relative movement parallel to the valve axis and oriented away from the valve stem body 82. The inner diameter of the sleeve 42 is equal to or slightly larger than the maximum outer diameter of the valve base 72 at its thickened valve base end. This not only creates a sufficiently large free passage space for a cannula or hollow needle to be inserted, but in particular also increases the stability of the sleeve against bending or buckling in the event of stresses acting radially on the sleeve. This also reduces the forces acting in the contact region between the sleeve and the valve base, which reduces the risk of loosening or breakage in this contact region. This not only increases the stability of the sleeve as such, but also increases the stability and fatigue strength of its connection to the rest of the valve system.

In addition, an intermediate section with a cylindrical outer circumference, which is formed by the region of the maximum outer circumference of the thickened valve base end of the valve base 72, not only frictionally anchors the sleeve 42 against being displaced along the valve axis but also supports it against tilting relative to the valve axis.

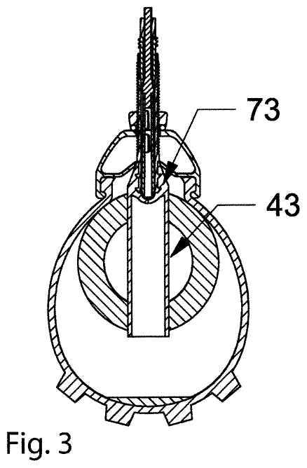

According to a third embodiment of the valve system according to the invention shown in FIG. 3, the sleeve 43 and the valve base 73 are embodied of one piece, i.e. as an integral component. The sleeve 43 is formed onto the valve base 73 as an element that extends the valve system along the valve axis; the sleeve 43 and valve base 73 can be manufactured in a combined production step in the multi-component injection molding process. In this case, the sleeve 73 has the same outer contour as the valve base 73. Such a one-piece embodiment of sleeve 43 and valve base 73 improves the sealing of the valve system against the passage of fluids.

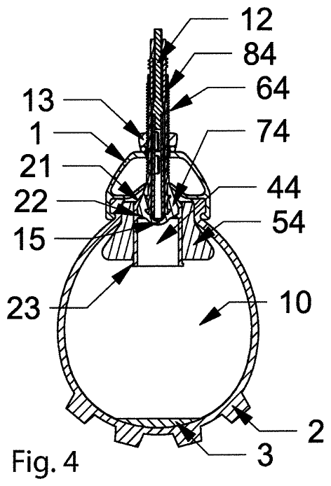

FIG. 4 shows a fourth embodiment of the valve system according to the invention. It is mounted in a tubeless wheel, which comprises a rim 1, a tire 2, and a puncture protection insert 54. The rim 1 and the casing of the tire 2 enclose a tire/rim volume 10, which can be sealed from the inside against air leakage by means of a liquid sealant 3. The puncture protection insert 54 has a cross-section that is compact, compared to the puncture protection insert 52 shown in FIG. 2, and that also extends into a partial region between the rim flanges and anchors the beads of the tire 2 against the rim flanges there. Similarly to the above-mentioned first and second embodiments, the valve system 64 also comprises a valve stem body 84, a valve base 74, and a sleeve 44, which is guided through the entire cross-section of the puncture protection insert 54 and in this way forms an extension of the valve system along the valve axis through the puncture protection insert 54. For this purpose, the puncture protection insert 54 has through openings whose dimensions are adapted to the dimensions of the sleeve 44. T he longitudinal span of the sleeve 44 is adapted to the dimensions of the puncture protection insert 54 in relation to the valve axis and is therefore shorter than the sleeve 42 according to the second embodiment shown in FIG. 2. At its first end, the sleeve 44 is positively connected to the valve base 74 by means of a frustoconical first retaining section 21, which tapers toward the valve base 74. This above-mentioned first retaining section 21 prevents the sleeve 44 from detaching from the valve base 74 by means of a first relative movement parallel to the valve axis and oriented away from the valve stem body 84. The inner diameter of the sleeve 44 is equal to or slightly larger than the maximum outer diameter of the valve base 74. In addition, an intermediate section of the valve base 74 with a cylindrical outer circumference not only frictionally anchors the sleeve 44 against displacement along the valve axis, but also supports it against tilting in relation to the valve axis.

The special feature of the embodiment shown in FIG. 4 compared to the above-mentioned embodiments according to FIG. 1 or 2 is that in addition to the first retaining section 21, the sleeve 44 also has a second retaining section 22 which, similarly to the first retaining section, reduces the free cross-section inside the sleeve 44, but has a smaller free cross-section than the first retaining section. This second retaining section cooperates with a corresponding second retaining section of the valve base 74 at the thickened valve base end. With respect to the first retaining section 21, this second retaining section 22 adjoins the distal or opposite second end of the above-mentioned intermediate section of the valve base 74. The first retaining section 21 and the second retaining section 22 thus form a retaining device, which embraces the valve base 74 on both sides in relation to the valve axis, prevents a relative movement between the sleeve 44 and valve base 74 in both axial directions along the valve axis, and thus positions the valve base 74 immovably in relation to the sleeve. The second retaining means 22 consists of a flexible material so that in the context of the mounting of the valve system, the cross-section of the second retaining means initially expands when the sleeve is pulled over the valve base 74 and springs back into its initial shape in the manner of a “snap mechanism” when the intended positioning of the sleeve 44 with respect to the valve base 74 is reached. Another special feature of the embodiment shown in FIG. 4 compared to the above-mentioned embodiments shown in FIG. 1 or 2 is that the sleeve 44 has a third retaining section at its distal second end in the form of a retaining edge 23 that enlarges the outer circumference of the sleeve. This prevents an axial movement of the insert 54 in the direction of the second end of the sleeve.

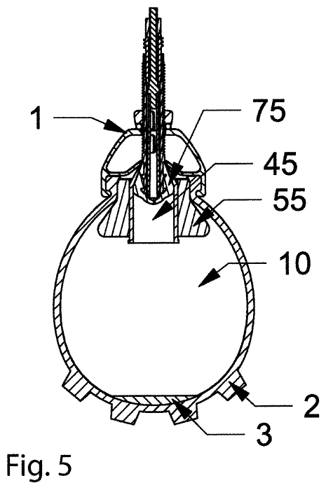

FIG. 5 shows a fifth embodiment of the valve system according to the invention. In this embodiment, in a modification relative to the fourth embodiment shown in FIG. 4, the sleeve 45 is extended so far beyond the valve base 75 in the direction of the valve stem body that the sleeve 45 is clamped between the valve base 75 and rim 1 when a valve system is mounted in a tubeless wheel, thus producing a seal of the tire/rim volume 10 against the rim 1 in the region of the valve system.

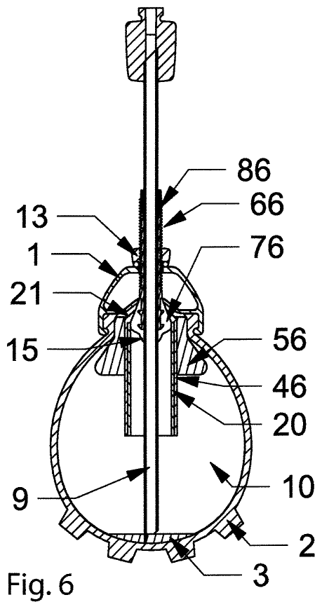

FIG. 6 shows a sixth embodiment of the valve system according to the invention. This is mounted in a tubeless wheel, which comprises a rim 1, a tire 2, and a puncture protection insert 56. The rim 1 and the casing of the tire 2 enclose a tire/rim volume 10, which can be sealed from the inside against air leakage by means of a liquid sealant 3. The puncture protection insert 56, similar to the insert 54 shown in FIG. 4, has a compact cross-section, which also extends into a partial region between the rim flanges and anchors the beads of the tire 2 against the rim flanges there. Similarly to all of the above-mentioned embodiments, the valve system 66 also comprises a valve stem body 86, a valve base 76, and a sleeve 46, which is guided through the entire cross-section of the puncture protection insert 56 and in this way forms an extension of the valve system along the valve axis through the puncture protection insert 56. For this purpose, the puncture protection insert 56 has through openings whose dimensions are adapted to the dimensions of the sleeve 46. The sleeve 46 is positively connected to the valve base 76 at its first end by means of a frustoconical first retaining section 21 that tapers toward the valve base 76. This above-mentioned first retaining section 21 prevents the sleeve 46 from detaching from the valve base 76 by means of a first relative movement parallel to the valve axis and oriented away from the valve stem body 86. The special feature of the embodiment shown in FIG. 6 compared to the above-mentioned embodiments is that the sleeve 46 is reinforced by means of an internal supporting body 20, which is also sleeve-shaped. To increase stability and improve the supporting effect of the supporting body 20, the sleeve 46 has an enlarged longitudinal span. The supporting body 20 consists of a material with a higher modulus of elasticity, e.g. a hard rubber with a Shore hardness of 50D, which exerts a shape-stabilizing action on the (softer) sleeve. By contrast, the sleeve 46 is made of a material with a lower modulus of elasticity, e.g. a soft rubber with a Shore hardness of 45A, which has good form-fitting properties in the contact region with the valve base 76 and enables the sleeve 46 to be easily mounted on the valve base 76.

FIG. 6 also shows a tool for sucking the liquid sealant 3 out of the tire/rim volume 10. The sealant 3 has collected at the lowest point of the wheel under the influence of gravity; the wheel is shown in a position in which the valve system 66 is approximately at the “6 o'clock position” in relation to the wheel circumference (i.e. is likewise at the lowest position). The valve core is removed from the valve system 65 to permit a hollow needle 9 of this above-mentioned tool to pass through it; the valve flaps 15 are secured in the open position by the hollow needle 9 that has been guided through them.

All the above-mentioned embodiments share the fact that the valve system also comprises a valve core 12 and is locked against the rim 1 in the direction of the valve axis by means of a nut 13 that can be screwed onto an external thread of the valve stem body. In the opposite direction from this, the valve system is held against the rim 1 by the outer contour of the valve base, which thickens along the valve axis A. In addition, the valve system shown in all of the exemplary embodiments has valve flaps 15 made of rubber in a manner known from the prior art, which are provided on the underside of each valve base oriented in the direction of the tire/rim volume 10 and form a safeguard that prevents air loss from the wheel when the valve cores are removed from the valve system.

One possible procedure for mounting the valve system according to the invention in a tubeless wheel is to push the valve stem body provided with the valve base through the sleeve in a first step and to fasten the sleeve to the valve base (this first step is of course not necessary if the valve base and sleeve are embodied of one piece). In a second step, the valve system (together with the sleeve) is pulled through the opening provided for this purpose in the anti-puncture insert. In the third and final step, the resulting subassembly is inserted into the tire/rim volume of the wheel, with the valve stem body being guided from the inside of the rim through the valve opening of the rim and anchored against the rim there by means of a screwable nut 13 from the outside of the rim. Alternatively, the valve system (together with the sleeve) can be pulled through the opening in a puncture protection insert that is already mounted in the tire/rim volume of the wheel.

1. A valve system (6, 62, 64, 66) for a tubeless wheel, the wheel comprising a rim (1) and a tire (2), which form a tire/rim volume (10) that can be filled with air, and a puncture protection insert (5, 52, 54, 55, 56) positioned inside the tire/rim volume (10), the valve system comprising:
a valve stem body (82, 84, 86), which extends along a valve axis (A) and has a first end and a second end, and a valve base (72, 73, 74, 75, 76) adjoining the second end, the second end being positioned in the tire/rim volume (10) when the valve system (6, 62, 64, 66) is mounted on the wheel;
wherein the valve base has an outer circumference that increases continuously along the valve axis (A) in the direction of the tire/rim volume, forming a thickened valve base end; and
a sleeve (4, 42, 43, 44, 45, 46) having a first end and a second end, wherein the first end of the sleeve (4, 42, 43, 44, 45, 46) connects to the thickened valve base end (72, 73, 74, 75, 76) and the sleeve (4, 42, 43, 44, 45, 46) extends from the thickened valve base end (72, 73, 74, 75, 76) along the valve axis in a direction oriented away from the valve stem body (82, 84, 86).

2. The valve system (6, 62, 64, 66) for a tubeless wheel according to claim 1, wherein the first end of the sleeve (4, 42, 44, 45, 46) is positively connected to the valve base (72, 74, 75, 76).

3. The valve system (6, 62, 64, 66) for a tubeless wheel according to claim 1, wherein the first end of the sleeve (4, 42, 44, 45, 46) has a retaining section (21) that tapers conically toward the valve base (72, 74, 75, 76).

4. The valve system for a tubeless wheel according to claim 1, wherein the first end of the sleeve is non-positively connected to the valve base.

5. The valve system for a tubeless wheel according to claim 1, wherein the sleeve (43) and the valve base (73) are embodied of one piece.

6. The valve system (6, 64) for a tubeless wheel according to claim 1, wherein the sleeve (4, 44) has a second retaining section (22), which is spaced apart from the first end of the sleeve (4, 44) in the direction of the second end of the sleeve (4, 44), with a free cross-section inside the sleeve that is reduced in size with respect to the first retaining section of the sleeve.

7. The valve system (66) for a tubeless wheel according to claim 1, wherein the sleeve (46) is stiffened by means of a supporting body (20).

8. The valve system (6, 64) for a tubeless wheel according to claim 1, wherein the second end of the sleeve (4, 44, 45) has a retaining edge (23) that enlarges the outer circumference of the sleeve (4, 44, 45).

9. A tubeless wheel with a valve system (6, 62, 64, 66) according to claim 1.
